(19) United States
(12) Patent Application Publication
(10) Pub. No.: US 2008/0229971 A1
(43) Pub. Date: Sep. 25, 2008

(54) Article of manufacture having sublimatable time delay thermochromic ink display

(76) Inventor: Wynn Wolfe, Arcadia, CA (US)

Correspondence Address: CHRISTIE, PARKER & HALE, LLP, PO BOX 7068, PASADENA, CA, 91109-7068, US

(21) Appl. No.: 11/726,977

(22) Filed: Mar. 22, 2007

(51) Int. Cl. C09D 11/00; B44C 1/165

(52) U.S. Cl. 106/31.13; 156/230

(57) ABSTRACT

A thermochromic ink display applied to a beverage container comprises a stepped sequence of images each applied over a separate thermochromic ink layer which is opaque at room temperature. The ink layers have different transition temperatures from opaque to transparent that reveal the images in a stepped time delay sequence when a hot drink is poured into the container. The images are applied over the thermochromic ink layers by sublimation techniques and can produce an animation effect, if desired.

### FIELD OF INVENTION

This invention relates to images applied to containers for holding beverages, and more particularly, to images which are hidden and revealed at intervals of time by temperature-activated thermochromic ink applied to the container.

### BACKGROUND

Thermochromic materials such as thermochromic ink layers can be applied to a substrate as image layers that hide a non-thermochromic image. Application of heat can cause the thermochromic ink layers to reach their transition temperatures at which they change state from opaque to transparent or colorless, for example. Different thermochromic materials (in different colors, for example) can have different transition temperatures. Thermochromic materials are disclosed in U.S. Pat. No. 5,202,677 to Parker et al.; U.S. Pat. No. 5,805,245 to Davis; and U.S. Pat. No. 5,223,958 to Berry, which are incorporated herein by reference. A ceramic beverage holding cup having a thermochromic time-sequence display is disclosed in U.S. Patent Publication 2002/0097777 to Ronci, also incorporated herein by reference.

### SUMMARY OF THE INVENTION

Briefly, one embodiment of this invention comprises a sublimatable thermochromic ink display on a beverage container adapted to sense temperature changes caused by a hot medium poured into the container. The thermochromic ink display comprises a stepped sequence of images each of which is positioned over a separate thermochromic ink layer which is opaque at room temperature. The images are transferred to a sublimation polymer layer overlying the thermochromic ink. In one embodiment, the images can be digital images printed on sublimation paper by sublimation ink, and transferred to the sublimation polymer under heat and pressure. The thermochromic ink layers have different transition temperatures from opaque to transparent. When a hot beverage is poured into the container, the opaque ink layers sense accumulating temperature changes at different times and transition to transparent in a stepped time delay sequence that reveals the overlying images in a sequence of steps. The images can be positioned to reveal an event that happens sequentially over time. In one embodiment, the images may contain slightly different figures that, when revealed in the time delay sequence, simulate the sequential motion effect of an animation, or a real life event; or a series of images may be revealed at different times.

In one form of the invention, the images can be combined with permanent graphics to produce the appearance and effect of the frames of a film strip or video format, or a movie reel, or picture frames, for example.

These and other aspects of the invention will be more fully understood by referring to the following detailed description and the accompanying drawings.

### BRIEF DESCRIPTION OF THE DRAWINGS

FIG. 1 is a perspective view showing a beverage container such as a coffee mug to which the sublimatable time delay thermochromic ink display of this invention is transferred according to principles of the invention.

FIG. 2 is a perspective view showing a step of applying a decorative decal prior to applying a thermochromic ink layer.

FIG. 3 is a perspective view of the beverage container depicting a subsequent step of transferring a decal containing thermochromic ink layers prior to the application of a sublimatable polymer for transferring a sequence of images to the container.

FIG. 4 is a perspective view showing the beverage container holding a hot beverage that has caused the thermochromic ink layers to transition from opaque to transparent and reveal previously hidden permanent images which are revealed in a stepped time delay sequence forming an animation that progresses from left to right.

FIG. 5 is a representation of a thermochromic image display that can be applied to the container, which in this instance illustrates three side-by-side frames of a movie strip in which all three frames initially comprise separately timed opaque thermochromic ink layers.

FIG. 6 shows an image display illustrating a first progression from that of FIG. 5 comprising a first step in the display that has been revealed by a first thermochromic ink frame having transitioned to transparent at a first lower temperature.

FIG. 7 shows an image display illustrating a second step in the progression in which more images are revealed when a second thermochromic ink frame has transitioned from opaque to transparent at a second intermediate temperature.

FIG. 8 shows an image display illustrating a third step in the progression in which further images are revealed when a third thermochromic ink frame has transitioned from opaque to transparent at a third higher temperature.

### DETAILED DESCRIPTION

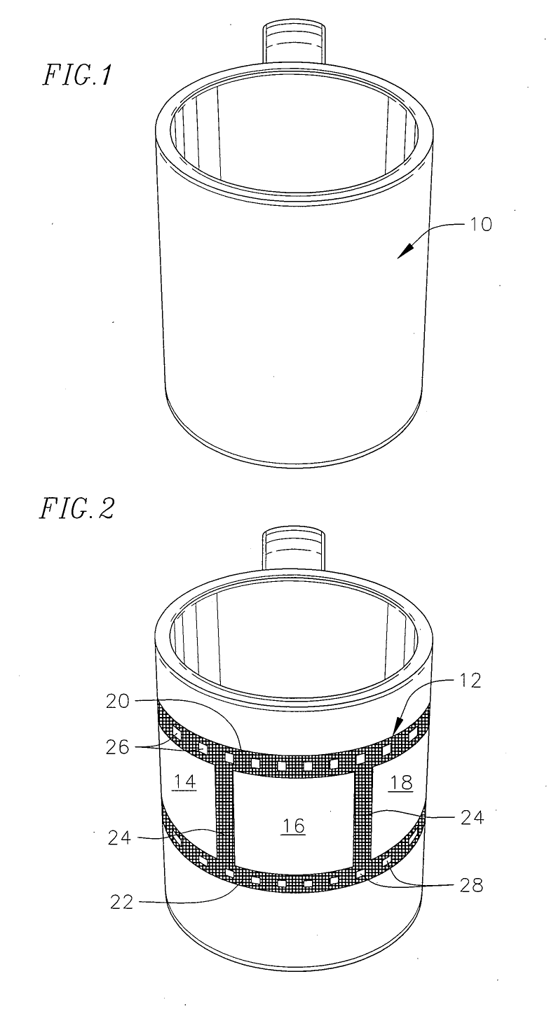

FIG. 1 illustrates a blank ceramic mug 10 to which a time-delay display is applied according to principles of this invention.

Referring to FIG. 2, a decal 12 is applied to an outside surface of the mug. The decal is in the form of an elongated film strip printed with a design forming a sequence of first, second and third frames 14, 16 and 18, respectively, extending across the front surface of the mug. At least two frames are provided for forming a time-delay sequence. The illustrated embodiment with three side-by-side frames is a preferred embodiment. The frames are defined by the rectangular surface areas within a series of rectangular borders formed by upper and lower horizontal lines 20 and 22, respectively, and spaced apart vertical lines 24. One form of the invention depicts a film strip that contains a three-frame sequence of images (described below). In the illustrated embodiment, upper and lower series of sprocket holes 26 and 28 extend across the upper and lower horizontal borders 20 and 22 of the film strip. Following application of the decal, the mug contains a blank film strip with rectangular blank areas inside the first, second and third frames. The base color of the mug shows through the blank areas inside the frames. In a preferred embodiment, a white or light colored background shows through the series of frames.

The decal used to produce the blank film strip image on the mug preferably comprises a water decal having the film frame design printed on the decal baseweb by conventional printing techniques. The wet decal is placed against the mug, after which heat is applied to bond the decal to the mug. Several methods can be used, one of which includes applying heat at high firing temperatures at about 2,400° F., causing the decal to become an integral part of the mug surface. Alternatively, the decal may be applied to the mug under low oven temperatures of about 300-350° F., sufficient for bonding the decal to the mug.

In an alternative form of the invention, the film strip border design of FIG. 2 can be applied permanently to the mug as conventional artwork, such as by pigmented ink or paint, followed by drying to integrate the design of the blank film strip permanently onto the surface of the mug.

FIG. 3 illustrates an embodiment of the invention which is produced by the next step in the process, in which a thermochromic ink decal 29 is positioned to overlie the frames of the permanent blank film strip of FIG. 2. The thermochromic ink decal is formed as a strip containing three side-by-side areas of thermochromic ink. Preferably, the three areas of thermochromic ink comprise first, second and third rectangular-shaped areas or regions 30, 32 and 34, respectively, positioned to overlie the first, second and third blank frames of the film strip. The three areas of thermochromic ink comprise ink compositions having different thermochromic transition temperatures at which the ink layers transition from pigmented or opaque to transparent or optically clear at different temperatures. In the illustrated embodiment of FIG. 3 the thermochromic ink layers are opaque at room temperatures. In one embodiment, the first thermochromic ink layer 30 has a transition temperature of about 40° C., the second thermochromic ink layer 32 has a transition temperature of about 50° C., and the third thermochromic layer 34 has a transition temperature of about 55° C. These temperatures in the sequence can of course be varied to produce different time delay effects, without departing from the invention.

In the next step of the process, a transparent sublimation polymer is applied as a coating to at least the outer surface of the thermochromic ink decal 29. Preferably, the sublimation polymer is applied to the entire outer surface of the container. The sublimation polymer is any of several fluid polymeric materials that promote a sublimation transfer process (described below) and which are familiar to those in the art. The sublimation polymer can comprise a material such as that known in the art as RN Coating, for example. The sublimation polymer coating is dried under heat applied at a temperature of about 400° F. The underlying thermochromic ink layers survive the heat applied to dry the outer layer of sublimation polymer, which in its dried form protects the underlying thermochromic ink layers and ultimately makes the product dishwasher safe according to minimum industry standards.

The container in the form illustrated in FIG. 3 represents a sublimatable “blank mug” in which the three side-by-side opaque thermochromic ink layers are coated by the dried transparent overlying layer of sublimation polymer. Thus, the blank mug has its sublimation layer exposed and covering the three side-by-side layers 30, 32 and 34 of thermochromic ink, which provide a sequence of functional time-delay frames with different transition temperatures.

In one embodiment, the sequence of transition temperatures can progress from lower to higher, from left to right, although other sequences are possible without departing from the invention. In the “blank mug” illustrated in FIG. 3, the layers of thermochromic ink are shown darkened to illustrate opacity but also the different temperature levels of the underlying frames of thermochromic ink.

According to the present invention, the blank mug can be used to accept a series of images that will be initially hidden and then revealed in a time-delay sequence, in response to heat transferred to the outer surface of the mug from a hot drink poured into the mug. In the illustrated embodiment, the images are in the form of media such as digital images printed by sublimation ink onto sublimation paper or other substrate material, which then can be used for transferring the images to the exterior of the mug by the following steps.

In one embodiment, the images can be created by digital photos which can be printed onto sublimation paper with sublimation ink, via a sublimation ink printer. The images can be sent over the internet, for example, to a print shop where the photos are downloaded and printed. The sequence of images can then be applied to a “blank mug” according to this invention, by sublimation transfer. The images can be arranged in a series that depicts a time sequence of events, or a common theme. They can be photos or pictures of a related sequence of events, but alternatively they can be other types of artwork, animation, words or text, or any other series of images including video images that are intended to be revealed at intervals of time.

The desired sequence of images is printed in the frames of a blank framework to form the sequence of images on a strip of sublimation media such as sublimation paper. The images on the sublimation paper are then aligned with the frames of the thermochromic decal formed on the mug. The sublimation paper images are printed with sublimation ink which can be accepted by the layer of sublimation polymer overlying the thermochromic decal. The mug is placed in a mug press and heat and pressure are applied at sufficient levels to transfer the images over the corresponding frames on the mug. In one embodiment, the mug press is operated at a temperature of about 400° F. This causes the ink to sublimate or vaporize and thereby transfer the printed images to the sublimation polymer layer by heat transfer vaporization or sublimation techniques. Following transfer of the images to the polymer which overlies the frames on the mug, the sublimation paper is removed. The finished product as illustrated comprises side-by-side images which are an integral part of the mug and which have been transferred over the areas of thermochromic ink having the different transition temperatures. Alternatively, more frames of similar imagery can be used, in addition to the three side-by-side images depicted in the drawings.

The finished mug with the images transferred to it has the appearance of side-by-side frames that are darkened in color (from the transferred images and the underlying opaque thermochromic ink) that do not reveal the true images at room temperature. When a hot liquid is poured into the mug, the heat from the liquid contained in the mug transfers to and through the wall of the mug to activate the thermochromic ink images on the mug. Since the images are sublimated into the polymer coating layer, the images are revealed one at a time in a timed sequence, controlled by the thermochromic ink frames, in a progression across the mug, say from left to right. Each of the images also is individually revealed in an upward direction. In one embodiment, the first image is revealed progressing upwardly, then followed by the image in the second frame in the same upward direction, followed by third image in the third frame in the same upward direction.

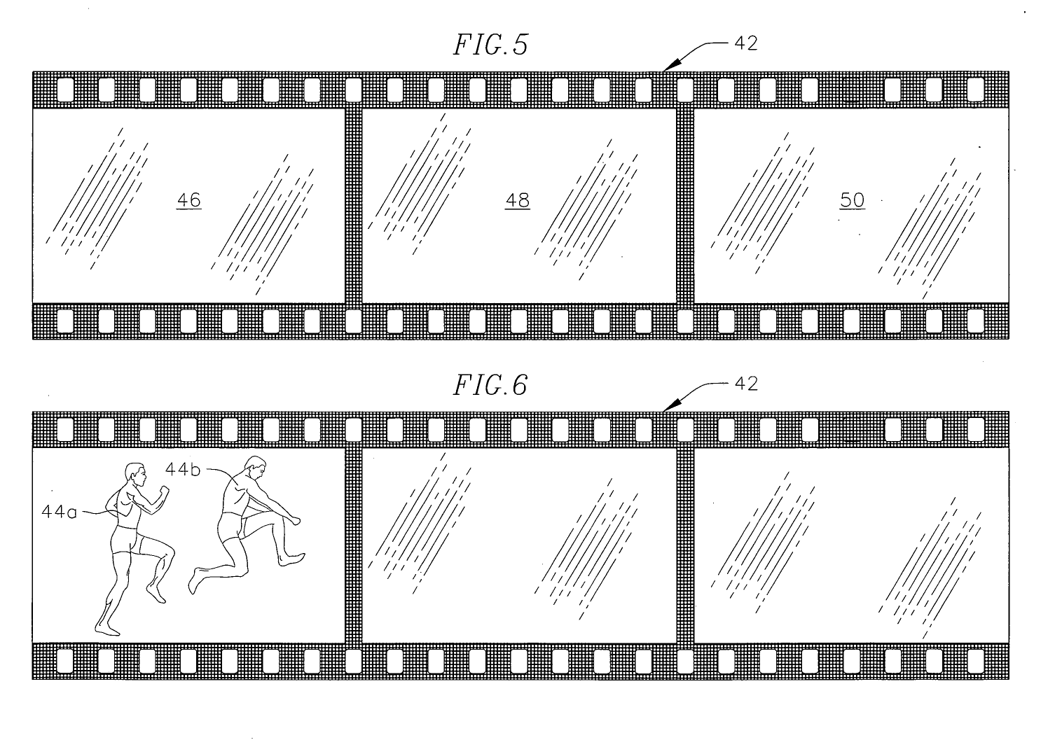

An example of the hide and reveal sequence of images being transferred to the mug is illustrated in the sequence of images shown in FIGS. 5 through 8.

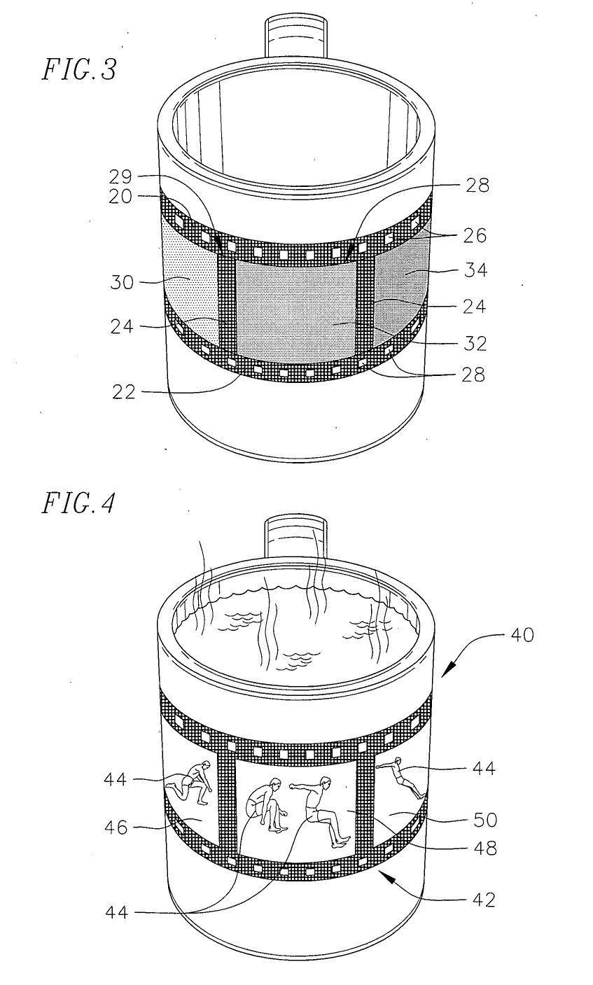

FIG. 4 illustrates a beverage container 40 having a thermochromic ink display 42 according to principles of this invention. The thermochromic ink display comprises a sequence of permanent graphics images 44 applied to the outer surface of the beverage container. The sequence of graphics images is presented in separate frames 46, 48 and 50 spaced apart side-by-side and progressing generally horizontally across the container. The permanent graphics images are normally hidden at room temperatures. They are revealed in FIG. 4 when a hot beverage is poured into the container.

As mentioned previously, the thermochromic ink layers each have a different temperature-responsive composition that causes each layer to transition to transparent at increasing, and therefore different, temperatures. FIG. 4 illustrates the condition at which each of the thermochromic ink layers has ultimately transitioned to transparent, and has thereby revealed the sequence of images. The white or light colored background provided by the container itself functions as a light source or projector and makes the images easily visible when the thermochromic ink layers transition from opaque to transparent.

FIGS. 5 through 8 illustrate an example of a time delay sequence of hiding and revealing the permanent graphics images so as to form the effect of a real life event. The sequence can be formed by images in the form of side-by-side figures or objects, each different from the next so that they can produce the visual effect of an animation or real life event when revealed in sequence. The drawings depict one example of the pictures 44a through 44f, illustrating a long jumper in slightly different poses which, when revealed in sequence, has the animation effect of real life motion.

FIG. 5 illustrates the graphics display at room temperature at which thermochromic ink layers 46, 48 and 50 are all opaque and the permanent images represented by the images 44 are hidden.

FIG. 6 illustrates the graphics display at a first relatively lower temperature (above room temperature) where the first thermochromic ink layer 46 has transitioned to transparent. This has revealed pictures 44a and 44b which form the first image in the sequence. The second and third frames which were covered by the different temperature sensitive thermochromic ink layers 48 and 50 remain opaque at the first relatively lower temperature.

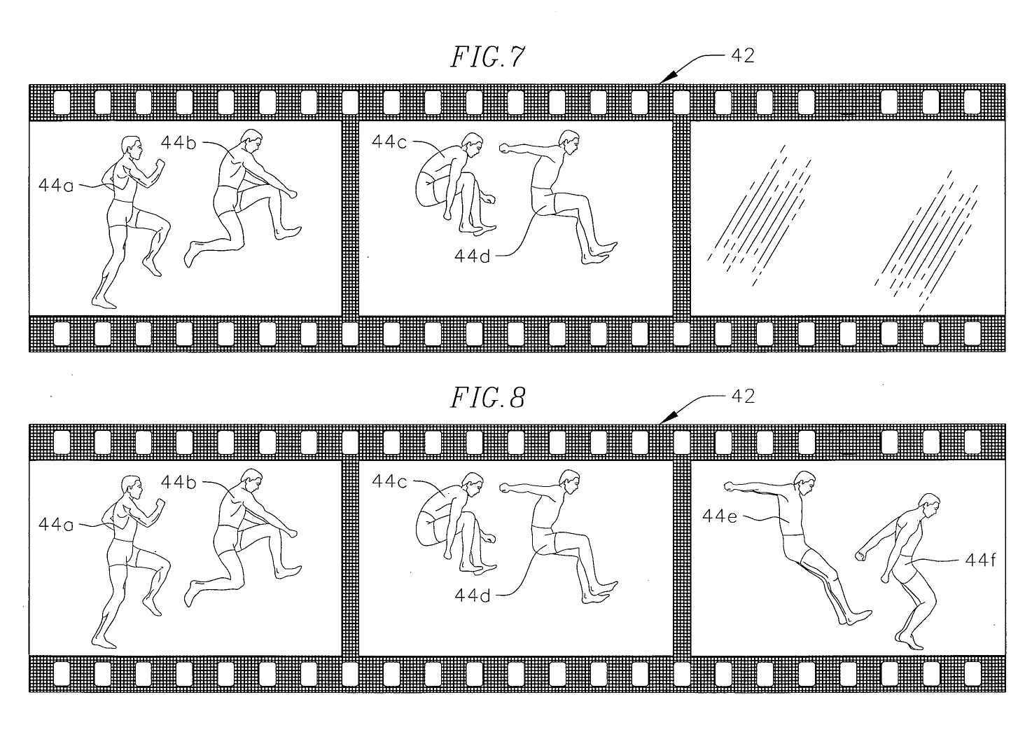

FIG. 7 illustrates the graphics display at a second intermediate temperature where the first thermochromic ink layer 46 remains transparent and the second thermochromic layer 48 has transitioned to transparent. This has revealed pictures 44c and 44d which form the second image in the animated sequence. The third frame which is covered by the third thermochromic ink layer 50 remains opaque at the intermediate temperature.

FIG. 8 illustrates the graphics display at a third relatively higher accumulated temperature where the first two frames remain revealed by their related transparent thermochromic ink layers and the third thermochromic ink layer 50 has transitioned to transparent. This has revealed pictures 14e and 14f which form the third image in the three-step progression of the animated sequence.

In one embodiment, the thermochromic ink layers are made from thermochromic ink materials having different transition temperatures from opaque to transparent. The thermochromic ink layers are positioned with the transition temperatures progressing higher in sequence from left to right to produce the visual effects depicted in FIGS. 5 through 8. In one embodiment, all ink layers are opaque at room temperature, i.e., up to at least about 100° F. (ambient temperature). The first thermochromic ink layer 30 has a transition temperature of about 45° C. (a range of about 105-110° F.); the second thermochromic ink layer 32 has a transition temperature of about 55° C. (a range of about 125-130° F.); and the third thermochromic ink layer 34 has a transition temperature of about 60° C. (a range of about 145-150° F.). (These transition temperatures are accumulative substrate temperatures.)

The thermochromic ink materials useful in producing the visual effects of this invention are available from Chromatic Technologies Incorporated (CTI), Colorado Springs, Colo.

The present invention has been described with respect to an animation time delay sequence of figures progressing from left to right, although the invention also can be carried out by a time delay sequence moving in the opposite direction, or in any other desired time delay sequence that can produce other animated visual effects. An example would be a sequence of animated images that are revealed in a random or deliberate sequence but not necessarily in a linear sequence as described previously. As mentioned, the imagery can be of various types, which can include depicting a common theme, in timed sequence, for example. The invention also has been described with respect to human figures each different from one another so that, when revealed in the stepped progression, they appear to move as real life figures. Separately, a series of pictures can be displayed. Similar animated graphics can be produced with inanimate objects to form a real life animation, or a message, for example.

What is claimed is:

1. A sublimatable thermochromic ink display for use on a beverage container comprising a stepped spatial sequence of separate thermochromic ink layers which are opaque at room temperature, the ink layers having different transition temperatures from opaque to transparent, and a layer of a sublimation polymer overlying the thermochromic ink layers, the sublimation polymer layer adapted to accept separate images by sublimation transfer thereto, the thermochromic ink layers adapted to sense temperature changes to transition from opaque to transparent to reveal images transferred thereto in a time dependent sequence of steps.

2. The display of claim 1 including a permanent graphics image depiction of separate frames with the images disposed in each frame.

3. The display of claim 2 in which the frames are depicted in the form of a film strip or video format.

4. The display of claim 1 in which the time dependent sequence is linear.

5. The display of claim 1 in which the time dependent sequence is nonlinear.

6. The display of claim 1 including separate images transferred by sublimation to the sublimation polymer layer that overlies each thermochromic ink layer.

7. A sublimatable thermochromic ink display disposed on a beverage container adapted to sense thermal changes caused by a hot medium poured into the container, the thermochromic ink display comprising a sequence of separate side-by-side layers of a thermochromic ink which is opaque at room temperature, the thermochromic ink layers having different temperatures at which they transition from opaque to transparent, and a layer of sublimation polymer overlying the thermochromic ink layers, the sublimation polymer layer adapted to accept separate images by sublimation transfer thereto, the thermochromic ink layers adapted to sense temperature changes to transition from opaque to transparent to reveal the separate images in a time dependent sequence of steps.

8. The product of claim 7, including a permanent graphics image depiction of separate frames with the images disposed in each frame.

9. The product of claim 8 in which the frames are depicted in the form of a film strip or video format.

10. The product of claim 7 in which the time delay sequence is linear.

11. The product of claim 7 in which the time delay sequence is nonlinear.

12. The product of claim 7 including separate images transferred by sublimation to the sublimation polymer layer that overlies each thermochromic ink layer.

13. A method for applying a thermochromic ink display to a beverage container, the method comprising:
providing a thermochromic decal having two or more regions of thermochromic ink having different transition temperatures from opaque to transparent, the thermochromic ink layers on the decal forming a spatial sequence each having a thermochromic ink layer with a different transition temperature,
applying the decal to the outer surface of a beverage container, the thermochromic ink layers in the different regions being opaque at room temperature, and transferring the regions of thermochromic ink to the container from the thermochromic decal, and
applying a sublimation polymer to cover the regions of thermochromic ink, to form a sublimation-ready beverage container with the sublimation polymer covering each region of thermochromic ink so that the polymer can accept a sublimatable image to be activated in time sequence by the thermochromic ink layers turning from opaque to transparent at different transition temperatures under heat transferred from a beverage in the container.

14. The method according to claim 13 in which the sublimatable images are applied under heat and pressure from sublimation media containing images printed with sublimation ink.

15. The method according to claim 13 including applying images of a sequence of frames to the container prior to applying the thermochromic decal, and aligning the regions of thermochromic ink with the separate frames.

16. The method according to claim 13 in which the images are formed by digital images, and optionally in which the digital images are transmitted electronically over the internet and downloaded to a sublimation ink printer for transfer to the sublimation media.
